(19) United States
(12) Patent Application Publication
(10) Pub. No.: US 2017/0312950 A1
(43) Pub. Date: Nov. 2, 2017

(54) REPLICATION TOOL

(71) Applicant: Anteryon Wafer Optics B.V., Eindhoven (NL)

(72) Inventors: Edwin Maria Wolterink, Eindhoven (NL); Willem Matthijs Brouwer, Eindhoven (NL); Marius Josephus Marcelis Minnen, Eindhoven (NL)

(21) Appl. No.: 15/498,068

(22) Filed: Apr. 26, 2017

(30) Foreign Application Priority Data
Apr. 28, 2016 (NL) 2016689

(51) Int. Cl. B29C 43/36; B29D 11/00; B29C 59/02; B29C 43/02

(52) U.S. Cl. CPC B29C 43/36; B29C 59/022; B29D 11/00009; B29C 43/021; B29C 59/026; B29C 2059/023; B29C 2043/025

(57) ABSTRACT

The present invention relates to a replication tool for replicating an element from a replication material, the replication tool comprising a replication side, a plurality of cavities on the replication side, each defining the shape of one element or a group of elements, the replication tool further comprising at least one bump portion, protruding, on the replication side, from the cavities, and further comprising means for confining the replication material to a predetermined area of the tool, when the tool is pressed against a substrate, which predetermined area exceeds the desired volume of the element in at least one direction along the surface of the substrate.

The present invention relates to a replication tool for replicating an element from a replication material, the replication tool comprising a replication side, a plurality of cavities on the replication side, each defining the shape of one element or a group of elements, the replication tool further comprising at least one bump portion, protruding, on the replication side, from the cavities, and further comprising means for confining the replication material to a predetermined area of the tool, when the tool is pressed towards a substrate, which predetermined area exceeds the desired volume of the element in at least one direction along the surface of the substrate.

Replication tools as mentioned here are known in the art, for example from EP 1 837 165. As discussed therein, when optical elements are produced by replication, there is often a basic configuration involving a substrate and replication material on a surface thereof, which replication material is shaped and hardened in the course of a replication process. Often, the dimension perpendicular to the named substrate surface—the thickness or height of the replicated structures, also termed z-dimension—is important and must be well-defined and controlled. Since the other dimensions of the element are defined by the replication tool—this being the nature of the replication process—also the volume of the replicated element is well defined. The replication tool disclosed in EP 1 837 165 comprises a plurality of cavities each defining the shape of one element or a group of elements, each cavity being limited, at least in one lateral direction, by a flat section. An inner edge is formed between the cavity and the flat section. The replication tool further comprises a plurality of overflow volumes or one contiguous overflow volume between the cavities. And an outer edge is formed between the flat section and the overflow volume. The dispensed replication material (per cavity) is chosen to be larger than the volume of the cavity. The flat section then serves as floating (non-contact) spacer, which surrounds the cavity. The outer edge constitutes a discontinuity stopping a flow the replication material. Without such discontinuities, capillary forces would cause the replication material to eventually drain the replication material from the element volume.

WO2015174929 relates to a replication tool for producing an optical structure comprising an optical element, the replication tool comprising a central section having the shape defining a negative of a portion of the optical structure, the central section having a vertically aligned central axis, a surrounding section laterally surrounding the central section, one or more contact standoffs defining a plane referred to as contact plane; wherein all portions of the replication tool are arranged on one and the same side of the contact plane, wherein the surrounding portion provides a surface facing away from the central axis, referred to as first compensation surface, and wherein the surrounding portion provides a surface facing away from the central axis, referred to as second compensation surface, wherein a steepness of the second compensation surface is higher than a steepness of the first compensation surface wherein the steepnesses are both defined as an increase in vertical coordinate of the respective surface per increase in distance from the central axis of the respective surface. This International application indicates that if the replication tool were rigid in and close to the retaining section, delamination or cracking of the replicated structure might take place when removing the replication tool after (at least partially) hardening the replication material. The retaining portion is a portion in which the replication tool extends particularly close to the contact plane, but does not touch it. The surrounding section comprises a retaining portion in which the replication tool, in the respective cross-section, has its smallest non-zero distance to the contact plane.

U.S. Pat. No. 9,279,964 relates to a wafer level optical lens structure, comprising: a light-transmissive substrate; a lens layer; and at least one stress buffer layer, disposed between the light-transmissive substrate and the lens layer, wherein the stress buffer layer is suitable for patterning. Such a stress buffer layer is disposed between the light-transmissive substrate and the lens layer, and is used for buffering a stress effect between the lens layer and the light-transmissive substrate, so as to decrease defects caused by the stress effect appeared during the fabrication process of the wafer level optical lens, for example, the defects generated due to lattice mismatch between the lens layer and the light-transmissive substrate, so as to improve the production yield of the wafer level optical lens.

US 2015/217524 relates to a tool for manufacturing, by replication, truncated passive optical components, wherein each of the truncated optical components is a passive optical component having a shape obtainable from a precursor passive optical component by truncation creating an edge and an edge surface adjacent to the edge, the tool comprising a replication surface, the replication surface having a shape not describing the edge surface, further comprising adjacent to the replication surface a surface referred to as flow-stop surface, the flow-stop surface and the replication surface forming an angle of at least 200°, in particular of at least 225°, more particularly of at least 260°. The flow-stop surface and the replication surface forming an edge in the location where the before-mentioned edge it to be formed. This US application furthermore relates to a method for manufacturing a device comprising a set of at least two passive optical components, the method comprising the steps of using a tool obtainable by carrying out tool, manufacturing steps, the tool manufacturing steps comprising the steps of manufacturing a precursor tool having a replication surface, modifying the replication surface by removing material from said precursor tool, wherein the replication surface of the precursor tool is suitably shaped for manufacturing by replication a passive optical component referred to as precursor passive optical component, wherein from the precursor passive optical component, a passive optical component of the set of passive optical components is obtainable by truncating the precursor passive optical component.

The present inventors noticed that full polymer optical elements which are replicated on a rigid or non-flexible substrate such as glass and are vulnerable to cracking of the cured optical element. In addition, cracks and delamination may occur in the final cured replica material.

Moreover, equivalent optical elements with optical coating, e.g. dielectric anti-reflective coating show additional cracks in the coating and at the interface with the replica material. These cracks occur when temperature variations cause excessive stresses between materials with different CTE values and stiffness in combination with roughness. Micro cracks appear at the interface between different materials and within the replica material. Since elements that are only partially filled are defective and lost, it is therefore advantageous to dispense excess replication material. By this, one makes sure that also for replication material volumes that fluctuate between different elements, no or only few elements are lost.

From the above discussed prior art references it is clear that UV an thermal cured polymer based lenses from prior art possess sharp transitions between the bottom of the optical element and the peripheral buffer layer, wherein the typical radius between the two surfaces is <<10 micron. Such a design is very vulnerable for cracking within lens material and in the optical coating, and also at the interfaces between glass, replica and coating layers, especially when subjected to thermal fluctuations during processing, transport storage and use. This phenomenon is in particular observed in replication systems using hard moulds and with stiff materials (E>2 GPa).

An aspect of the present invention is thus to provide a replication tool that reduces excessive stress and thereby prevents the formation of cracks in the materials and optical coatings.

The present invention thus relates to a replication tool for replicating an element from a replication material, the replication tool comprising a replication side, a plurality of cavities on the replication side, each defining the shape of one element or a group of elements, the replication tool further comprising at least one bump portion, protruding, on the replication side, from the cavities, and further comprising means for confining the replication material to a predetermined area of the tool, when the tool is pressed towards a substrate, which predetermined area exceeds the desired volume of the element in at least one direction along the surface of the substrate, characterized in that said at least one bump defines a curved surface transition zone having a fillet radius R in a range of 50 micron-300 micron.

The present inventors found that the implementation of a curved surface transition zone having a fillet radius R in a range of 50 micron-300 micron reduces excessive stress. Thus the formation of cracks in the materials and optical coatings is highly reduced or even prevented. In an embodiment the curved surface transition zone has a fillet radius R of maximally 200 micron. In an embodiment the curved surface transition zone has a fillet radius R in the range of 50-200 micron.

According to a specific embodiment of the present invention the at least one bump defines a curved surface transition zone having a fillet radius R in a range of 100 micron to 120 micron.

The present replication tool is further characterized in that each cavity being limited by the curved surface transition zone serving as the bump portion, an inner edge between the cavity and the transition zone, an overflow volume and an outer edge between the transition zone and the overflow volume. In such an embodiment the outer edge defines a peripheral resin run out zone with an inclination angle e in a range of 1-35 deg. In a preferred embodiment the length of said peripheral resin run out zone is at least 20 micron, preferably at least 50 micron, more preferably in a range of 60-90 micron.

The present inventors found that stresses are further reduced trough thinner buffer layers in the transition zone. In this way, a gradual build-up of buffer layer reduces risk of delamination and material fracture. The distance between said curved surface transition zone and said substrate, when the tool is pressed towards a substrate, is preferably less than 60 micron, preferably in a range of 20-40 micron, said distance being measured at the highest point of said curved surface transition zone.

While the fillet radius R mainly prevents cracks and the buffer layer thickness in the transition zone 6 mainly addresses delamination, both technical features provide a synergistic effect. In addition, as an inclination e of the peripheral buffer zone enables a smooth and evenly distributed flow of replica material from the center towards the edge 4, this aspect will result in a well controlled decenter of the contour of edge with the optical axis.

The present invention furthermore relates to a method of manufacturing an element by means of a replication tool, comprising the steps of:

providing a replication tool that defines the shape of the element;

providing a substrate;

pressing the replication tool towards the substrate, with a replication material in a liquid or viscous or plastically deformable state located between the tool and the substrate;

confining the replication material to a predetermined area of the substrate, which predetermined area exceeds the desired area of the element on the substrate, in at least one direction along the surface of the substrate by less than a predetermined distance;

hardening the replication material to form the element, wherein said replication tool is a replication tool according to anyone or more of the preceding claims.

On basis of the above discussed replication tool the present inventors found that smooth mold surfaces minimize stress build within resin material, optical coat and interfaces between the coat, resin and substrate. In addition, smooth mold surfaces have resulted in a uniform resin spread, thereby minimizing decenter of contour. Furthermore, replicated materials are easier to release from smooth mold surfaces.

In addition, in the present replication tools no additional layer stress relief layers are needed. Also, no stand-offs are needed in molds. The present method enables high optical elements with high shape accuracy using hard molds (>0.8 GPa (2-30 GPa). CTE 10<30 ppm/K)

The accompanying drawings are included to provide a further understanding of the invention, and are incorporated in and constitute a part of this specification. The drawings illustrate embodiments of the invention and, together with the description, serve to explain the principles of the invention.

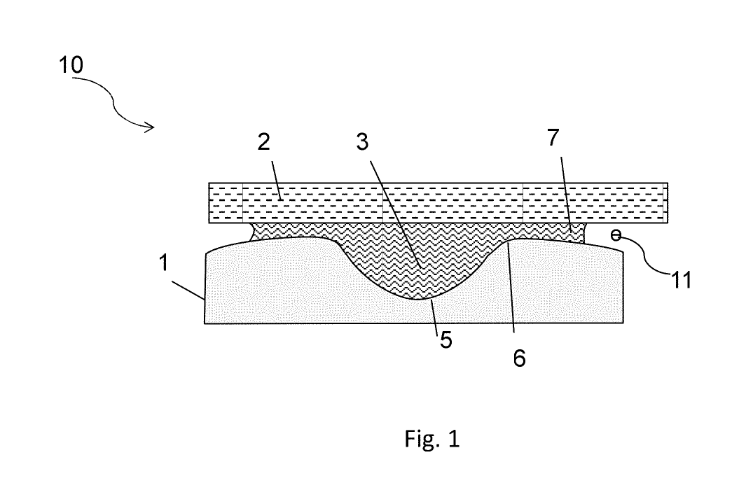

FIG. 1 shows an embodiment of a replication tool according to the present invention.

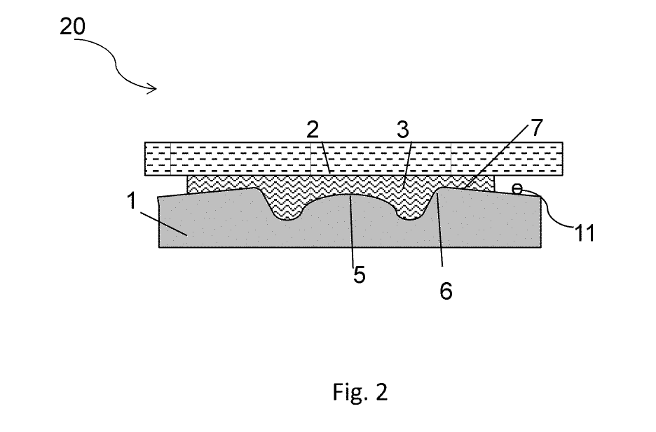

FIG. 2 shows an embodiment of a replication tool according to the present invention.

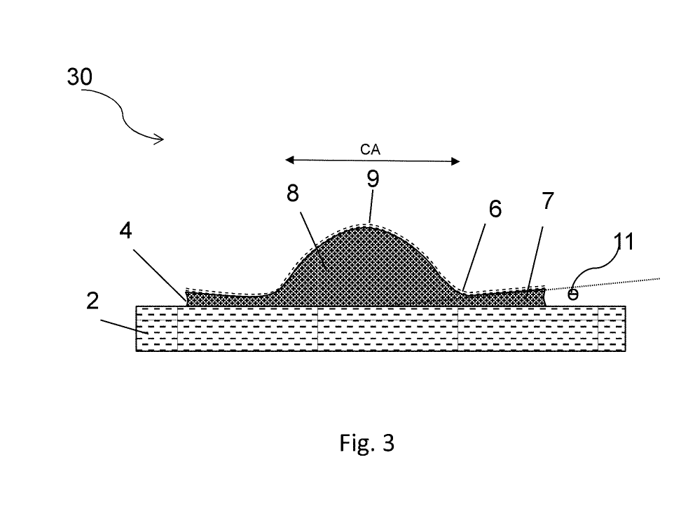

FIG. 3 shows a replicated lens obtained by a replication tool according to the present invention.

FIG. 1 shows an embodiment of a replication tool according to the present invention. A replication tool 1 for replicating an element from a replication material 3, comprises a replication side, a cavity 5 on the replication side, defining the shape of one element, the replication tool 10 further comprises a bump portion 6, protruding, on the replication side, from the cavity 5, and further comprising means for confining the replication material to a predetermined area of the tool, when the tool is pressed towards a substrate 2, which predetermined area exceeds the desired volume of the element 3 in at least one direction along the surface of the substrate, i.e. an overflow volume 7. The bump portion 6 defines a curved surface transition zone having a fillet radius R in a range of 20 micron-300 micron. There is a distance between the tool 1 and the substrate 2, which distance is the smallest between the bump 6 and the substrate 2. The tool is hence nearly pressed towards the substrate but not completely in order to allow for a distance between the tool and the substrate. In other words the tool is pressed towards the substrate at a predetermined distance. This predetermined distance can be controlled by different methods, such as through positioning algorithms of the replication and/or a mechanical spacer. This spacer can be provided by the replication machine or can be integrated as an additional feature in the mold 1 as disclosed in the standoff 15 in WO 2015174929 and contact spacer 9 in EP 1 837 165. Construction 20 shows a replication 10 and a substrate provided with a polymer material 3.

FIG. 2 shows an embodiment of a replication tool according to the present invention. The main difference between replication tool 1 shown in FIG. 1 and replication tool 1 shown in FIG. 2 is the number of cavities 5. Construction 20 shows a replication 10 and a substrate provided with a polymer material 3. Peripheral zone comprises a buffer layer 7 with a thickness of <60 micron (preferred 20-40 micron) at the smallest distance of transition zone 6.

FIG. 3 shows a replicated lens obtained by a replication tool according to the present invention.

The minimum peripheral buffer thickness at transition zone, i.e. the shortest distance between substrate 2 and bump portion 6 is <60 micron, preferably 20-40 micron, since a value of >60 micron favors delamination. The minimum thickness is determined by capability replication process and by design.

The outer edge defines a peripheral resin run out zone with an inclination angle e in a range of 1-35 deg, wherein the slope may be linear or curved.

The present inventors found that such a minimum slope is needed for promoting centrifugal resin flow. Shape edge 4 (see FIG. 3) is determined by the meniscus of resin 3 or by other post processing processes thereby limiting the width (lithography, laser ablation). The preferred buffer width zone is in a range of 60-90 micron. Relevant application dimensions of lens 8 are: sag heights of optical elements: 5-2000, typically 60-350 microns; diameter clear apertures: between 50-4000 micron (typically 200-2000 micron). Typical material properties: cured polymer lens elements, wherein the related optical materials have CTE (>30 ppm/K) and E<4 GPA. Hard polymeric molding materials E>0.8 GPa (2-30 GPa), CTE 10<30 ppm/K. Stiff substrate (e.g. glass, quartz), (E>40 GPa and CTE<13 ppm/K) and optical coatings CTE: <10 ppm/K.

The present invention has been shown in the Table,

| | Embodiment | Reference | Embodiment | Reference |
|---|---|---|---|---|
| | 1 | 1 | 2 | 2 |
| Molding | E = 4 GPa | E = 4 GPa | E = 6 GPa | E = 6 GPa |
| material | | | | |
| CA | 200 micron | 200 micron | 300 micron | 300 micron |
| Sag | 100 micron | 100 micron | 200 micron | 200 micron |
| Fillet radius R | 110 | 2 | 100 | 30 |
| Buffer | 30 micron | 30 micron | 25 micron | 100 micron |
| thickness | | | | |
| @ edge 4 | | | | |
| inclination | 15 deg | 25 deg | 15 deg | 0 deg |
| angle θ | | | | |
| run out zone 7 | | | | |
| Length run | 70 micron | 70 micron | 80 micron | 80 micron |
| out zone 7 | | | | |
| Cracks in/at | TiO2 SiO2 | TiO2 SiO2 | TiO2 SiO2 | TiO2 SiO2 |
| coat | Dielectric | Dielectric | Dielectric | Dielectric |
| | No cracks | cracks | No cracks | cracks |
| Failure in/at | No | Yes | No | Yes |
| material | | | | |

The Table shows the results of a design of experiment having different parameters. In “Embodiment 1” and the corresponding Reference the effect of the fillet radius has been shown. In “Embodiment 2” the corresponding Reference the effect of the application of a thinner buffer layer has been shown. The results have been provided in the bottom two rows.

1. A replication tool for replicating an element from a replication material, the replication tool comprising a replication side, a plurality of cavities on the replication side, each defining the shape of one element or a group of elements, the replication tool further comprising at least one bump portion, protruding, on the replication side, from the cavities, and further comprising means for confining the replication material to a predetermined area of the tool, when the tool is pressed against a substrate, which predetermined area exceeds the desired volume of the element in at least one direction along the surface of the substrate, characterized in that said at least one bump defines a curved surface transition zone having a fillet radius R in a range of 50 micron-500 micron.

2. The replication tool of claim 1, wherein said at least one bump defines a curved surface transition zone having a fillet radius R in a range of 100 micron to 120 micron.

3. The replication tool according to claim 1, wherein each cavity being limited by said curved surface transition zone serving as the bump portion, an inner edge between the cavity and the transition zone, an overflow volume and an outer edge between the transition zone and the overflow volume.

4. The replication tool according to claim 3, wherein said outer edge defines a peripheral resin run out zone with an inclination angle e in a range of 1-35 deg.

5. The replication tool according to claim 4, wherein the length of said peripheral resin run out zone is at least 20 micron, preferably at least 50 micron, preferably in a range of 60-80 micron.

6. The replication tool according to claim 2, wherein the distance between said curved surface transition zone and said substrate, when the tool is pressed against a substrate, is less than 60 micron, preferably in a range of 20-40 micron, said distance being measured at the highest point of said curved surface transition zone.

7. A method of manufacturing an element by means of a replication tool, comprising the steps of:
providing a replication tool that defines the shape of the element;
providing a substrate;
pressing the replication tool against the substrate, with a replication material in a liquid or viscous or plastically deformable state located between the tool and the substrate;
confining the replication material to a predetermined area of the substrate, which predetermined area exceeds the desired area of the element on the substrate, in at least one direction along the surface of the substrate by less than a predetermined distance;
hardening the replication material to form the element, wherein said replication tool is a replication tool according to anyone or more of the preceding claims.
